(19) United States
(12) Patent Application Publication
(10) Pub. No.: US 2009/0204473 A1
(43) Pub. Date: Aug. 13, 2009

(54) CUSTOMIZED HEALTH BEVERAGE SYSTEM

(75) Inventor: Audrey Sommerfeld, Hermosa Beach, CA (US)

Correspondence Address: BROOKS KUSHMAN P.C., 1000 TOWN CENTER, TWENTY-SECOND FLOOR, SOUTHFIELD, MI, 48075, US

(73) Assignee: VISALUS HOLDINGS, LLC, Troy, MI (US)

(21) Appl. No.: 12/028,336

(22) Filed: Feb. 8, 2008

(51) Int. Cl. G06Q 10/00

(52) U.S. Cl. 705/10

(57) ABSTRACT

A system and method for providing a customized health beverage system based on the preferences of a consumer. The customized health beverage system provides a flavor component list identifying a number of flavor components. The customized health beverage system also provides a health component list identifying a number of health components. The consumer is presented the flavor and health component list. The method includes a step of receiving from the consumer a customized health beverage preference based on the consumer's selection of health and flavor components from the health and flavor component lists. The consumer is provided the selected flavor and health components selected.

### BACKGROUND

1. Technical Field

According to one or more embodiments, the present invention relates to a customized health beverage system based on the preferences of a consumer.

2. Background Art

Several techniques are known for providing customized beverages. For example, U.S. Pat. No. 5,766,665 to Miller discloses a method of preparing a multi-flavored customizable shake. As another example, U.S. Pat. No. 6,808,731 to Gutwein et al. discloses a process for providing a customized fresh-brewed coffee beverage on demand by a consumer. The fresh-brewed coffee can be delivered in a wide range of variety of strength. As yet another example, U.S. Pat. No. 6,126,983 to Miller discloses a flavored shake drink that is prepared from a prepackaged neutral flavored mix stored within a serving cup. These techniques are limited in their use to restaurant or service facilities.

### SUMMARY OF THE INVENTION

According to one embodiment of the present invention, a system and method for providing a customized health beverage system based on the preferences of a consumer is disclosed. The customized health beverage system includes the step providing a flavor component list identifying a number of flavor components. The customized health beverage system also includes the step of providing a health component list identifying a number of health components. The consumer is presented the flavor and health component list. The consumer selects a customized health beverage preference based on the consumer's selection of health and flavor components from the health and flavor component lists. The consumer is provided the selected flavor and health components selected.

### BRIEF DESCRIPTION OF THE DRAWINGS

FIG. 1 is a simplified, exemplary flowchart according to one embodiment of the present invention;

FIG. 2 is a computing environment for implementing one or more methods of the present invention;

FIGS. 3A and 3B depict a simplified, exemplary diagram depicting a computer system embodiment according to the present invention; and

FIG. 4 is a simplified, exemplary diagram depicting another computer system embodiment according to the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

Health beverages are becoming increasingly more popular in today's society. One form of health beverage currently on the market is a premixed health shake. Premixed health shakes are typically flavored and include one or more vitamin supplements. For example, the premixed health shake may be chocolate flavored with an iron supplement. Premixed health shakes can be purchased through online sources or brick and mortar stores, such as health and/or grocery stores. As a drawback, the product offerings are limited to pre-determined flavor/supplement combinations selected by the supplier. As such, the consumer is unable to customize the health beverage.

Moreover, if the customer currently wants flavor variety using this scenario, they need to purchase multiple products at a significant out of pocket expense. Also, personally customized combinations are not contemplated under this scenano.

In light of the foregoing, a customized health beverage system has been devised in which a customer is able to customize based on a combination of consumer flavor and health preferences. With the inventive system and method of embodiments of the present invention, a consumer is allowed to buy one basic shake mix flavor, and add and customize with flavors and health components instead of purchasing multiple shakes.

Further, the system includes suggested combinations of one or more flavor components and one or more health components. The suggested combinations can be selected based on the connection of the components to each other or the connection of each component to a common theme. Moreover, the suggested combinations can change based on the time of the year, thereby producing a dynamic customized health shake system. Further, the systems and methods of one or more embodiments of the present invention are personalized by the consumer anytime and/or anywhere.

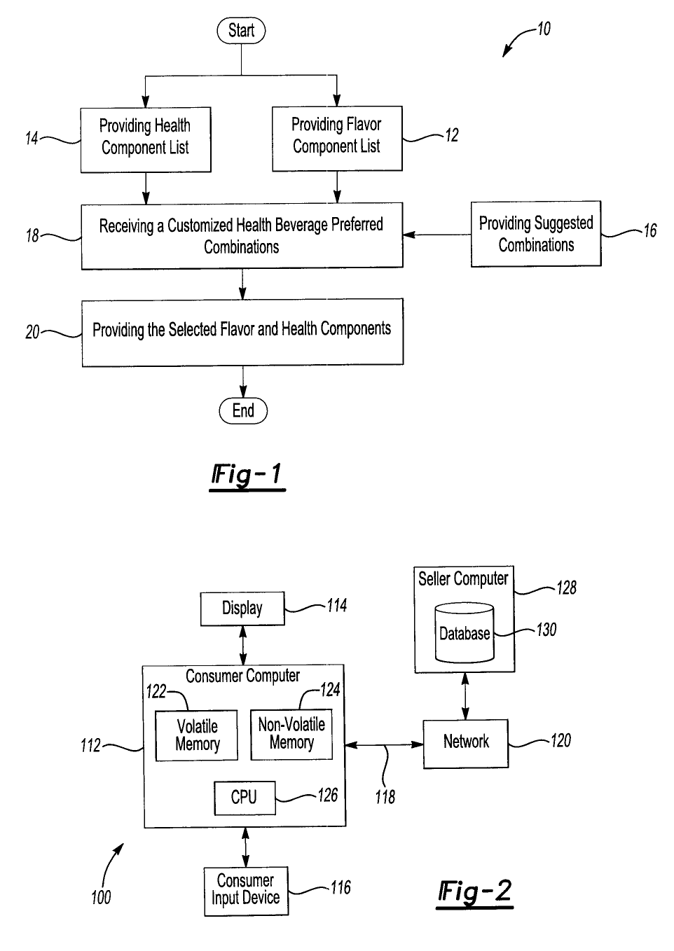

Turning to FIG. 1, a flowchart 10 is depicted. The flowchart 10 illustrates a method of delivering a customized health beverage system according to one embodiment of the present invention. It should be appreciated that the steps of flowchart 10 can be modified, rearranged, and/or omitted according to a specific implementation of the present invention, and any step or portion thereof can be carried out by a user, a computer or in combination according to the particular implementation of the present invention.

According to block 12, a flavor component list identifying a list of flavor components is provided. Non-limiting examples of groups of flavor components include flavor extracts (such as spearmint, peppermint or wintergreen), fruit flavors (such as pineapple, apple, orange or mixed berry), spice flavors (such as cinnamon, nutmeg or cardamom), dessert flavors (such as pumpkin pie or peaches and cream) and herbal flavors (such as mint or lemon grass). It should be appreciated that these groups are not necessarily mutually exclusive. In one embodiment, the flavor component list is defined by the seller of the customized health shake system, or related entity. The seller may be a mail order company, an online retailer, or an offline retailer. The flavor component list is provided to a consumer of the customized health shake system.

According to block 14, a health component list identifying a list of health components is provided. Non-limiting examples of groups of health components include diet components (such as a hydroxycitric acid salt), health components (such as antioxidants), vitamin components (such as vitamin A, B or E), nutritional components (such as whey protein), mineral components, phyto nutrient components and/or herbal components (such as ginseng). It should be appreciated that these groups are not necessarily mutually exclusive. In one embodiment, the health component list is defined by the seller of the customized health shake system, or related entity. The seller may be a mail order company, an online retailer, or an offline retailer. The health component list is provided to a consumer of the customized health shake system.

In one embodiment, the flavor component and health component lists are contemporaneously presented to a consumer so that the lists can be viewed side-by-side during the process of selecting a combination of flavor and health components.

According to block 16 of FIG. 1, suggested combinations of flavor and health components are provided. The flavor and health components for the suggested combination can be selected based on a cooperative relationship between the flavor and health components. For example, the suggested combination may be a “peaches and cream” flavor component and a complexion health component, such as zinc, thiamine and/or vitamin E, to provide a cooperative formulation for a “peaches and cream” complexion.

The flavor and health components for the suggested combination can be selected based on a common theme. The common theme can be based on a period during the year, such as a season. For example, during the fall season, the suggested combination may be a pumpkin spice flavor component and one or more health components typically utilized to ward off the common cold during the fall. Such health components may include vitamin E and/or C.

Another seasonal combination may include a watermelon hydration combination that may be presented to a consumer during the summer season. Hence, the consumer may be presented a watermelon flavor component. Also, health components may be presented to assist in re-hydrating the consumer during warm, summer days. Such health components may include a calcium component and/or a vitamin B component.

The thematic and/or cooperative suggested combinations can be changed during any given time period over any given interval. For example, a consumer may order a twelve month subscription of a customized health beverage program wherein the suggested combination(s) change each month.

According to block 18, a customized health beverage preference combination is received. The combination itself can be consumer-selected or based on a suggested combination.

The customized health beverage preference combination is used to gather and provide the selected flavor and health components, as depicted in block 20. In one embodiment, the flavor and health components are provided as a powder in a single, sealed package. In one embodiment, the consumer adds the powder to a base shake mix and water to obtain the resulting shake with flavor and functional benefits.

Moving to FIG. 2, a computer system 100, which is suitable for implementing one or more embodiments of the present invention, is depicted. Computer system 100 includes consumer computer 112, display 114, consumer user interface 116, communication line 118 and network 120.

Consumer computer 112 includes volatile memory 122, non-volatile memory 124 and central processing unit (CPU) 126. Non-limiting examples of non-volatile memory include hard drives, floppy drives, CD and DVD drives, and flash memory, whether internal external, or removable. Volatile memory 122 and/or non-volatile memory 124 can be configured to store machine instructions and data relating to customization of health beverages. CPU 126 can be configured to execute machine instructions to implement functions of the present invention, for example, receiving data, and formatting received data for display. For example, the machine instruction can implement one or more steps of any method for providing a customized health beverage system based on the preferences of a consumer.

The consumer can use display 114 of consumer computer 112 to view information, e.g., flavor and health component lists and/or suggested combinations according to one or more methods disclosed herein. A non-limiting example display 114 is a color display, e.g., a liquid crystal display (LCD) monitor or cathode ray tube (CRT) monitor.

The consumer input device 116 can be utilized by a user to input instructions to be received by consumer computer 112. The instructions can be instructions for viewing information related to the methods disclosed herein. The user input device 116 can be a keyboard having a number of input keys, a mouse having one or more mouse buttons, a touch pad or a trackball or combinations thereof.

Consumer computer 112 can be configured to be interconnected to network 120, the communication line 118, for example, a local area network (LAN) or wide area network (WAN), through a variety of interfaces, including, but not limited to dial-in connections, cable modems, high-speed lines, and hybrids thereof. Firewalls can be connected in the communication path to protect certain parts of the network from hostile and/or unauthorized use.

Consumer computer 112 can support TCP/IP protocol which has input and access capabilities via two-way communication lines 118. The communication lines can be an intranet-adaptable communication line, for example, a dedicated line, a satellite link, an Ethernet link, a public telephone network, a private telephone network, and hybrids thereof. The communication lines can also be intranet-adaptable. Examples of suitable communication lines include, but are not limited to, public telephone networks, public cable networks, and hybrids thereof.

The network 120 can be utilized to transmit data residing on database 130 from computer 128 to computer 112. Such data can be flavor and health component lists and/or suggested combinations. A seller of customized health beverage systems can administer the seller computer 128.

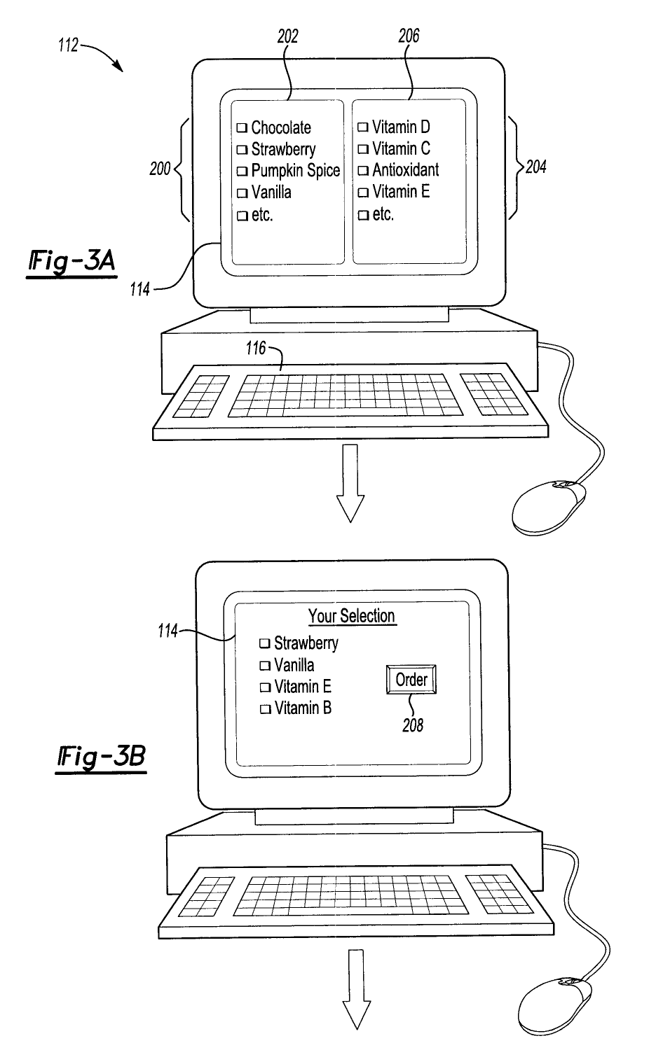

With reference to FIGS. 3a, a method of the present invention is implemented using consumer computer 112 via consumer input device 116 (keyboard) and display 114 (monitor). FIG. 3a further illustrates that a consumer may select one or more flavor components 200 (chocolate, strawberry, pumpkin spice, vanilla, etc.) from a flavor component list 202 and one or more health components 204 (vitamin D, vitamin C, antioxidant, vitamin E, etc.) from a health component list 206. Consumer computer 112 may receive a consumer input, which is reflected on display 114 of FIG. 3b, that relates to the consumer's selection of the at least one flavor component and the consumer's selection of the at least one health component. As depicted in FIG. 3b, the consumer selected strawberry, vanilla, vitamin E and vitamin B. The consumer's selection is finalized by selecting the order button 208 on display 114. Once received, the consumer order is electronically processed so that the consumer may be provided the selected flavor and health components.

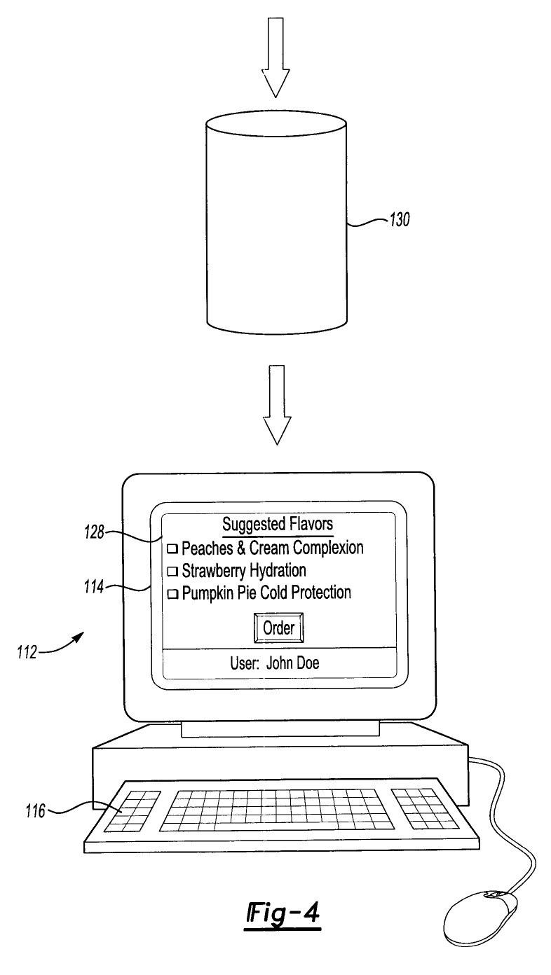

With reference to FIG. 4, a method of the present invention is implemented using consumer computer 112 via consumer input device 116 (keyboard) and display 114 (monitor). FIG. 3a further illustrates that a consumer may select one or more flavor components 200 (chocolate, strawberry, pumpkin spice, vanilla, etc.) from a flavor component list 202 and one or more health components 204 (vitamin D, vitamin C, antioxidant, vitamin E, etc.) from a health component list 206. The selected health components and flavor components can be stored to database 130.

The database 130 can also store suggested combinations of flavor and health components, which are transmitted by seller computer 128 across network 120, to consumer computer 112, for display on display 114. The suggested flavor and health component combination may be formed of the at least one flavor component and at least one health component that relate to the health and flavor preference of the consumer's prior selections. For example, the consumer may select from the health component list an antioxidant component and an iron component. Also, the consumer may select from the flavor component list a chocolate flavor and a strawberry flavor. Once received by the seller computer 128, the antioxidant component, the iron component, the chocolate component and the strawberry component is stored on the database 130. Thereafter, the consumer may be presented with a suggested flavor combination that includes a chocolate antioxidant boost beverage system or a wildberry iron beverage system. The suggested flavor and health component combinations may be formed from at least one flavor component and at least one health component that relate to the health and flavor preference of the consumer's prior selections.

Alternatively, the consumer may be presented with a customized health beverage system in an offline retail setting (not shown). The consumer may be presented the flavor component list and the health component list upon which a customized health beverage preference may be based. The customized health beverage preference may be provided to a store clerk who, in turn, provides the consumer the selected flavor and health components. The present invention also contemplates that a display may be provided in order to present the consumer the available flavor and health components. As such, the consumer may select any number of flavor and health components from the provided display.

The present invention also contemplates that a flavorless base may also be provided to the consumer. For example, a flavorless shake base may be provided to the consumer. The consumer may mix the flavorless shake base with the provided health and flavor components so as to form a customized health shake. Another example includes a flavorless malt base being provided to the consumer. The consumer may mix the flavorless malt base with the provided health and flavor components so as to form a customized health malt.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Thus, specific details disclosed are a merely a representative basis for teaching one skilled in the art to practice the present invention.

What is claimed is:

1. A method for providing a customized health beverage system based on the preferences of a consumer, the method comprising:
providing a flavor component list identifying a number of flavor components;
providing a health component list identifying a number of health components;
presenting the flavor and health component lists to the consumer;
receiving a customized health beverage preference based on the consumer selecting at least one flavor component from the flavor component list and the consumer selecting at least one health component from the health component list; and
providing the consumer the selected flavor and health components using the customized health beverage preference, the provided flavor and health components being used to form the customized health beverage system.

2. The method of claim 1, further comprising providing a suggested flavor and health component combination to the consumer, the suggested flavor and health component combination being formed of at least one flavor component from the flavor component list and at least one health component from the health component list.

3. The method of claim 2, further comprising the suggested flavor and health component combination being based on the cooperative flavor and health relation between the at least one flavor component selected and the at least one health component selected.

4. The method of claim 2, further comprising the suggested flavor and health component combination being formed of at least one flavor component and at least one health component that each relate to the same season of the year.

5. The method of claim 2, further comprising presenting the consumer the suggested flavor and health component combination.

6. The method of claim 1 further comprising:
presenting the flavor component list and the health component list through an electronic consumer interface;
receiving through the electronic consumer interface, a consumer input relating to the consumer's selection of the at least one flavor component and the consumer's selection of the at least one health component;
electronically processing the consumer input; and
providing the consumer the selected flavor and health components using the received consumer input.

7. The method of claim 6 further comprising:
storing the consumer input relating to the consumer's selection received through the electronic consumer interface; and
presenting a suggested flavor and health component combination to the consumer, the suggested flavor and health component list being formed of at least one flavor component and at least one health component relating to the health and flavor preference of consumers prior selections.

8. The method of claim 1 further comprising, providing the consumer the flavored component from the group consisting of a extract flavor, fruit flavor, spice flavor, dessert flavor, herbal flavor.

9. The method of claim 1 further comprising, providing the consumer the health component from the group consisting of a diet component, health component, vitamin component, herbal component.

10. The method of claim 1 further comprising, providing a flavorless shake component to the consumer adding the flavorless shake component to a liquid along with the flavor and health component in order to form a customized health shake.

11. A method for providing a customized health shake system based on the preferences of a consumer, the method comprising: providing a flavorless shake component for adding to a liquid base in order to form a flavorless shake base;
providing a flavor component list that identifies a number of flavor components, wherein at least one flavor component is added to the flavorless shake base in order to form a flavored shake;
providing a health component list that identifies a number of health component, wherein at least one health component is added to the flavored shake in order to form the customized health shake;
presenting the flavor and health component list to the consumer;
receiving a customized health shake preference based upon the consumer selecting at least one flavor component from the flavor component list and the consumer selecting at least one of the health component from the health component list; and
providing the consumer the selected flavor and health components using the customized health shake preference, the provided flavor and health components being combined with the flavorless shake component to form the customized health shake system.

12. The method of claim 11, further comprising providing a suggested flavor and health component combination to the consumer, the suggested flavor and health component combination being formed of at least one flavor component from the flavor component list and at least one health component from the health component list.

13. The method of claim 12, further comprising the suggested flavor and health component combination being based on the cooperative flavor and health relation between the at least one flavor component selected and the at least one health component selected.

14. The method of claim 12, further comprising the suggested flavor and health component combination being formed of at least one flavor component and at least one health component that each relate to the same season of the year.

15. The method of claim 12, further comprising presenting the consumer the suggested flavor and health component combination.

16. The method of claim 11 further comprising:
presenting the flavor component list and the health component list through an electronic consumer interface;
receiving through the electronic consumer interface, a consumer input relating to the consumer's selection of the at least one flavor component and the consumer's selection of the at least one health component;
electronically processing the consumer input; and
providing the consumer the selected flavor and health components using the received consumer input.

17. A customized health beverage system comprising:
a flavor component list;
at least one flavor component being identified through the flavor component list, wherein one or more of the flavor components are selected from the flavor component list based on a desired flavor preferences of an consumer; a health component list; and
at least one health component being identified through the health component list, wherein one or more of the health components are selected from the health component list based on a desired health preferences of the consumer, and the consumer being provided the selected flavor and health components in order to form the customized health beverage system.

18. The customized health beverage system of claim 17 further comprising a flavorless component for adding with the selected flavor and health components in order to form a customized health shake.

19. The customized health beverage system of claim 17 further comprising an electronic consumer interface for receiving a consumer's selection of at least one flavor component and at least one health component.

20. The customized health beverage system of claim 17 further comprising an electronic consumer interface for displaying a consumer's previous selection of at least one flavor component and at least one health component.
